(19) United States
(12) Patent Application Publication
(10) Pub. No.: US 2006/0084489 A1
(43) Pub. Date: Apr. 20, 2006

(54) Design matching game with bar code for confirmation

(76) Inventor: Karl P. Boehm, Vienna, VA (US)

Correspondence Address: SETO PATENTS, 406 RIVERLAND DR., SALEM, VA, 24153, US

(21) Appl. No.: 10/966,431

(22) Filed: Oct. 18, 2004

(51) Int. Cl. G06F 17/00; G06F 19/00

(52) U.S. Cl. 463/17

(57) ABSTRACT

A matching game that requires the pairing of designs on game pieces wherein each design is complex and not easily identifiable. Multiple game pieces are provided with a design on the front and some type of confirmation information on the back. Matching designs have identical types and shapes however, the matching designs are different in coloring or shading, which adds difficulty to the game but also enhances the male-female aspect of the present matching game. In the preferred embodiment, the confirmation information is provided in the form of a barcode on each game piece. When two players believe they have found their match, the players take their game pieces to a verification station, which includes a bar code scanner that reads the bar codes and verifies whether or not a match has been found. The bar codes on matching game pieces can be identical or they may merely be associated with each other through the use of a correlation table that is stored within the scanning device.

### BACKGROUND OF THE INVENTION

The present invention relates generally to the field of matching games, or memory games, and more specifically to a game of finding matching designs wherein each game piece has a bar code that is used to confirm a correct match.

A matching, or memory, game is a game where players try to find matching pairs of game pieces from among multiple pieces that are provided in the game. Such a game is commonly used as an “ice-breaker” at social events. Typically, the host of the social event explains the rules of the game, hands out the game pieces, assists the players as needed, and hands out prizes to the winners. A game that is closely related to the present matching game uses mechanical locks and keys. In this lock-and-key game, the locks are given to the female players and the keys are given to the male players. Each key is able to unlock only one of the locks. When the game begins users attempt to find their matching lock or key by process of trial and error. The present invention is different from lock-and-key games by the process in which possible matches are eliminated, i.e., visually and then by electronic verification. Other matching games require that multiple cards with images on them be turned over two at a time in repeated attempts to find matches. When all the possible matches have been found the game is over. This type of matching game includes simple designs, such as distinct pictures of animals, and is geared toward younger players. There are also unrelated (non-matching) card games that include a barcode reader to identify the type and features of a game piece, such as “a soldier” and the types of weapons available. However, a game that requires the players to find the match to a complex design wherein potential matches can be verified with barcode reader is lacking in the field.

### SUMMARY OF THE INVENTION

A matching game wherein each player is provided with a game piece that includes a design and the players are instructed to find the match to their game piece. The game requires close scrutiny of multiple designs in order to find a matching pair of designs. The matching game comprises an even number of game pieces, in the preferred embodiment, with each game piece having a front and a back. The front of each game piece has at least one design thereon and the back of each game piece has a barcode thereon. A scanning device is also provided capable of scanning the barcodes and indicating to the players when matching or otherwise associated barcodes have been successively scanned. Each game piece has at least one matching game piece and the matching game piece has a matching barcode and a matching design. In the preferred embodiment, the matching design to a game piece is the same in style and design as the design on the game piece, but different in color or shading.

In an alternative embodiment, the design on the front of each game piece includes at least one hidden attribute that under a specific light, such as florescent “black” light for example, reveals or makes more apparent certain shapes or color schemes that help contrast or match the game piece to the other game pieces.

In a second alternative embodiment, the barcode is replaced by a hidden identifier that is revealed by special lighting stations, that use a specific light, such as florescent “black” light for example, to reveal the hidden identifier and verify correct matches.

It is an object of the present invention to provide a game that requires players to match not easily identifiable designs, wherein the designs may be separated by color or a unique identifier such as an “O” on one card and an “X” on that card's match.

### BRIEF DESCRIPTION OF THE DRAWINGS

The invention of the present application will now be described in more detail with reference to the accompanying drawings, given only by way of example, in which:

FIG. 1 is a frontal view of an exemplary game piece;

FIG. 2 is a back view of an exemplary game piece;

FIG. 3 shows a confirmation device that can is used in the preferred embodiment; and,

FIG. 4 is a flow chart showing steps in the preferred method of playing the present matching game.

### DETAILED DESCRIPTION OF THE INVENTION

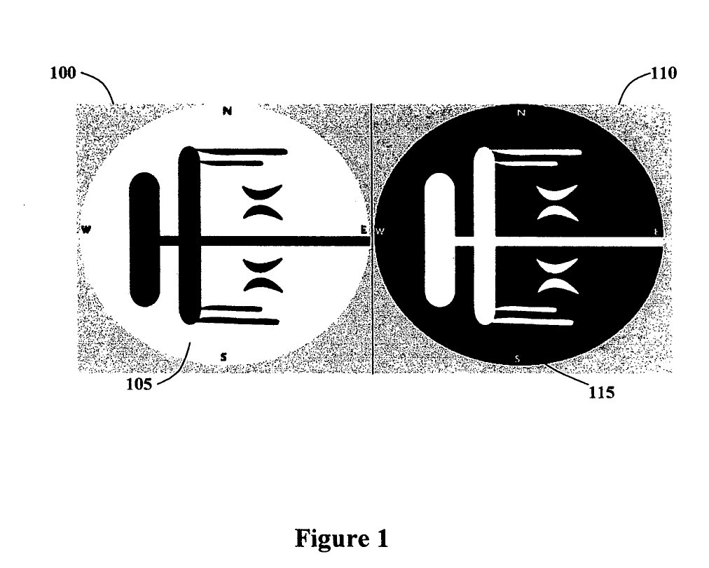

FIG. 1 shows the front of two exemplary game pieces 100 and 110 of the present invention. Game piece 100 includes design 105, which is the design for which a match must be found. Game piece 110 includes design 115, which is the match for design 105. Designs 105 and 115 are intentionally complex so players are forced to give each game piece careful consideration in order to find their match. In the preferred embodiment, each game piece 100 and 110 is provided with a perspective key so players can properly position the designs 105 and 115 for comparison purposes. In this embodiment, the perspective key comprises north, south, east and west symbols that indicate the top, bottom, right and left sides, respectively, of each design 105 and 115. Also in the preferred embodiment, the matching designs 105 and 115 have the same shape but are opposite in shading, if black and white designs are used, and different in color, if colors are used. In FIG. 1, the shape of each design is comprised of many sections, however all sections in each design 105 and 115 are identical. The only difference between the two designs 105 and 115 is the shading. This difference enhances the “matching” aspect of the present game by inferring a male-female type match. The multiple sections of each design also allow for many possible subtle differences between any two game pieces.

In an alternative embodiment, the designs 105 and 115 on the front of each game piece also serve as confirmation codes. In this embodiment, a confirmation device, such as a scanner with image recognition software, is used to scan the designs of the two game pieces and confirm to the players that the game pieces are matching game pieces.

In another alternative embodiment, the only difference between matching designs is a unique identifier, such as an “X” or “O”. In this embodiment, matching designs are the same in shading, however, one of the sections in the first design includes an “X” and a corresponding section in the matching design includes a “O”. Of course, other identifiers can be used such as a series of dashes or dots. In such a case, a key can be provided to show matching identifiers.

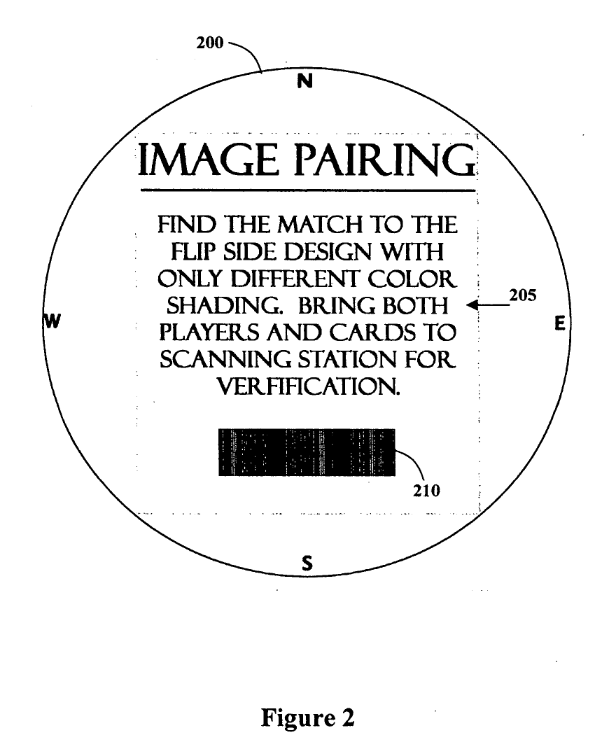

FIG. 2 shows the back of a game piece 200 in the preferred embodiment. The back of the game piece 200 includes instructions 205 for playing the present game and a barcode 210. The instructions are succinct and provide the player with all of the information needed to play the game. The barcode 210 can be scanned by any well-known scanning device for accurate identification of the game piece 200. In the preferred embodiment, the same values are stored in the barcodes of matching game pieces. This allows a simple matching algorithm to be used by the scanning device for determining whether or not two game pieces are a match. Of course, other methods, or matching algorithms, may be used by the scanning device to confirm a match. For example, unique values can be stored in each barcode and the values of matching game pieces can be stored in a correlation table that is used by the scanning device to confirm matches.

In an alternative embodiment, the barcode 210 is placed on the front of the game piece so that both the design and the barcode are provided on the front of the game piece. In this embodiment, the back of the game piece may be left blank so that a one-sided game piece is provided.

In another alternative embodiment, the barcodes on each game piece are replaced by hidden identifiers that can only be read under a specific type of light, such as red light or florescent “black” light, and the barcode scanner is replaced by a light station that includes the specific type of light. In this embodiment, when two players believe they have found their match, the game pieces are held underneath of the specified light and the hidden identifiers are revealed. The revealed identifiers are then used to verify a match.

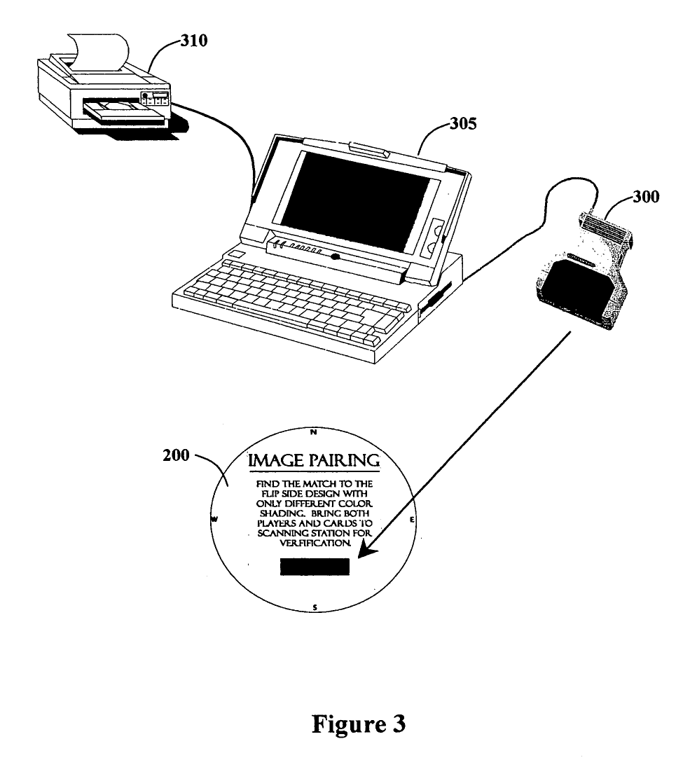

FIG. 3 shows a hand-held scanning device 300 that can be used in the confirmation station of the present game. The barcodes on the backs of each game piece can be read by scanning device 300. In the preferred embodiment, when scanning device 300 reads two successive barcodes that are identical the scanning device 300 indicates a match with sounds, such beeps or a song, and may also use visual indicators such as lights or images on a display screen, such as the screen of computer 305. The confirmation station may also include a printer 310 for printing out labels or certificates with date-time stamps indicating when a match between two game pieces was confirmed. Time stamps allow easy tracking of first, second and third place winners in the present game.

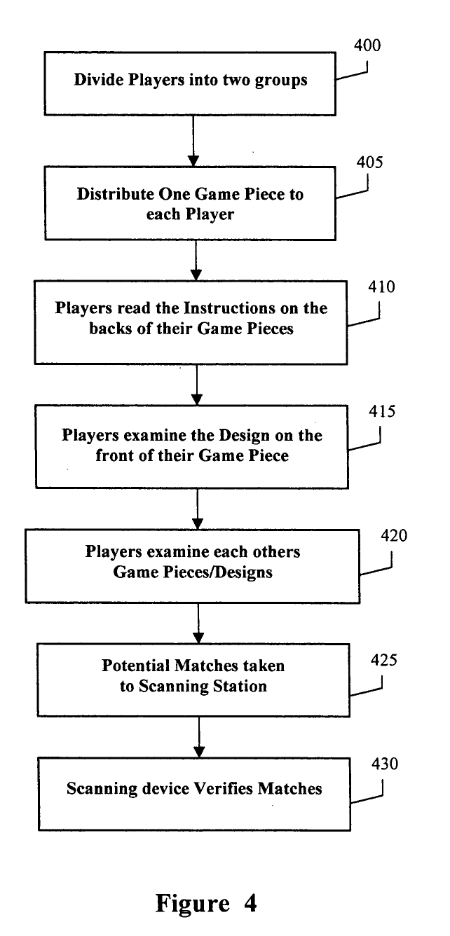

FIG. 4 is a flow chart showing the steps in the preferred embodiment of the present game. In step 400, the players are divided into two groups, such as males and females, for example. In step 405, one game piece is given to each player, preferably with females receiving the matches to game pieces given to the male players. If the players are not divided into male and female groups, then two sets of wristbands can be given to the players so the players can easily identify which players are in their group and which players have potential matches to their game piece. Alternatively, the game pieces themselves may include an identifier, such as a color, that classifies the game piece into one of two groups. Thus, players will not waste time searching for matches within their own group. In step 410, the players read the instructions on the backs of their game pieces. In the preferred game, each game piece includes the same instructions. Of course if there is a host, the instructions can be read to the players by the host and the instructions do not need to be printed on each game piece. At the end of step 410 the players know that the object of the game is to find the “match” to the design on their game piece. In step 415, the players examine the design on the front of their game pieces. This examination lets players know what design they need to search for. In step 420, the players must interact with each other so that designs on other game pieces can be examined for potential matches. When two players believe that their game pieces are matches, the players take their game pieces to a confirmation station, step 425. At the confirmation station the barcodes on the backs of the two game pieces, in the preferred embodiment, are scanned one after the other. In step 430, the confirmation device indicates to the players, with sounds or displays or both, whether or not there is a match.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A matching game wherein each player is provided with one game piece and wherein the game requires close scrutiny of multiple designs in order to find a matching pair of designs, the matching game comprising:
multiple game pieces wherein each game piece has a front and a back, the front of each game piece having at least one design thereon and the back of each game piece having confirmation information thereon, wherein the confirmation information is used to confirm a match between two game pieces, and further wherein the confirmation information cannot be read directly by players of the game; and,
a confirmation device capable of transferring the confirmation information into information that can be understood by the players and thereby verifying whether or not a correct match has been made;
wherein, each game piece has at least one matching game piece and matching game pieces have matching designs and correlating confirmation information.

2. The matching game of claim 1, wherein the confirmation information on each game piece is a bar code and the confirmation device is a bar code scanner.

3. The matching game of claim 1, wherein the confirmation information on each game piece on only visible under a specific type of light, including black florescent light, and the confirmation device includes the specific type of light.

4. The matching game of claim 1, wherein the matching design to a game piece is the same in style and design as a design on the game piece, but different in color or shading, than the design on the game piece.

5. The matching game of claim 1, wherein the confirmation device indicates a match with lights, sound or both.

6. The matching game of claim 1, wherein the back of each game piece includes printed instructions for playing the game and wherein the confirmation device includes a computer and a printer capable of printing a certificate with a date-time stamp indicating when matching pairs of designs were confirmed by the confirmation device.

7. The matching game of claim 1, wherein the design on the front of each game piece includes at least one portion that is only visible under a specific type of light, and further comprising:
a light station that includes the specific type of light, wherein players can view otherwise hidden attributes within the design on their game piece by placing the design under the specific type of light.

8. The matching game of claim 1, wherein the at least one design on the front of each game piece is complex and includes multiple sections.

9. The matching game of claim 1, wherein the at least one design and the confirmation information are both on the front of each game piece.

10. The matching game of claim 9, wherein the confirmation device includes a computer with image recognition software and the at least one design is also used as the confirmation information, wherein matching designs can be recognized and indicated by the confirmation device.

11. A method for playing a matching game, wherein multiple game pieces are provided, each game piece having a front with a design thereon and a back with confirmation information thereon, and wherein a confirmation device is provided, the method comprising the steps of:
distributing one game piece to each of multiple players;
reading the instructions to the players
having each player examine the design on the front of their game piece;
requiring the players to find a match to their game piece, wherein the match for each game piece has a matching design;
providing a confirmation station that includes the confirmation device where two players can take their game pieces to verify whether or not they have found their match; and,
indicating to the players, by the confirmation station, whether or not their match has been found.

12. The method of claim 11, wherein the confirmation information on each game piece is a bar code and the confirmation device is a bar code scanner.

13. The method of claim 11, wherein the confirmation information on each game piece on only visible under a specific type of light, including black florescent light, and the confirmation device includes the specific type of light

14. The method of claim 11, wherein the step of reading is replaced with the step of, requiring the players to read instructions that are printed on the backs of each game piece.

15. The method of claim 11, wherein the design and the confirmation information are both on the front of each game piece.

16. The method of claim 15, wherein the confirmation station includes a computer with image recognition software, the design on each game piece includes multiple sections and at least one of the sections is used as the confirmation information, wherein matching sections can be recognized and indicated by the confirmation device.

17. The method of claim 11, wherein matching designs are the same in style and shape but different in shading or color.

18. The method of claim 11, wherein the design on the front of each game piece includes at least one portion that is only visible under a specific type of light, and the step of having each player examine, further comprises:
providing a light station that includes the specific type of light, wherein players can view otherwise hidden attributes within the design on their game piece by placing the design under the specific type of light.

19. The method of claim 11, wherein the step of distributing further comprises:
dividing the players into a first group and a second group and then distributing one game piece to each player so that each player in the first group ends up with a matching game piece to a player in the second group.

20. The method of claim 11, wherein the confirmation station includes a computer and a printer that are able to print out certificates with date-time stamps when pairs of matching game pieces have been confirmed by the confirmation device.
